(19) United States
(12) Patent Application Publication
(10) Pub. No.: US 2009/0300683 A1
(43) Pub. Date: Dec. 3, 2009

(54) SYSTEM AND METHOD FOR SCHEDULING AN AUDIOVISUAL INFORMATION RECORDING

(75) Inventor: Bogdan Rynkowski, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,469

(22) PCT Filed: Dec. 13, 2005
(86) PCT No.: PCT/IB2005/054221

§ 371 Date: Jun. 12, 2007

Related U.S. Application Data
(60) Provisional application No. 60/635,681, filed on Dec. 13, 2004.

(51) Int. Cl. G06F 13/00; H04N 5/91

(52) U.S. Cl. 725/58; 386/83; 386/E05.001

(57) ABSTRACT

A novel method and system is provided for scheduling the recording of audiovisual information based on pre-programmed user specified criteria including at least one user preferred channel and user preferred content description. In a preferred embodiment, applicable to the Digital Video Broadcasting (DVB) standard, a broadcast stream conformant to the Digital Video Broadcast (DVB) specifications defines a plurality of program categories and sub-categories from which a user selects preferred categories/sub-categories. Broadcasted events in conformance with a DVB broadcast stream are automatically recorded based on the user specified preferred categories/sub-categories.

This invention relates generally to the field of recording of audiovisual information. More particularly, the invention relates to a method and system for scheduling the recording of audiovisual information based on user specified criteria including one or more user preferred services (channels) and associated user preferred service event categories/sub-categories.

A number of tools have been proposed or suggested for recommending television programming. The TiVo™ system, for example, commercially available from TiVo, Inc., of Sunnyvale, Calif., allows viewers to rate shows using a “Thumbs Up and Thumbs Down” feature and thereby indicate programs that the viewer likes and dislikes, respectively. Based on the “thumbs-up/thumbs-down” feature, thereafter, the TiVo receiver matches the recorded viewer preferences with received program data, such as an EPG, to make recommendations tailored to each viewer. Such recommenders are well known in the art. A viewer may also explicitly provide a “wish list” of movie or program criteria. For example, by entering words like “KITCHEN REMODEL”, TiVo works like a search engine to find programs, features, or anything at all to do with creating a dream kitchen.

In contrast to currently available systems like TiVo, the invention allows a viewer to schedule the automatic recording of audiovisual information based on precise user specified criteria without having to establish a user profile based on viewer likes and dislikes or by creating a so-called “wish list”.

Generally, a novel method and system is provided for automatically recording audiovisual information based on user preference criteria.

In an embodiment applicable to the Digital Video Broadcasting (DVB) standard, the user preference criteria is comprised of one or more user preferred services (channels) and user preferred category and optional sub-category descriptors for selecting events scheduled for broadcast on the one or more user preferred services.

In accordance with an aspect of the invention, a method for automatically recording audiovisual information received as part of a broadcast stream over a communication medium, wherein the broadcast stream is comprised of a plurality of services, each service being further comprised of a plurality of events and service information describing the plurality of events, generally comprises the acts of: (a) creating user preference criteria comprised of at least one user preferred service and associated user preferred service information (SI); (b) extracting service information (SI) from the broadcast stream for a plurality of events to be broadcast on the at least one user preferred service; (c) comparing the extracted service information (SI) with the user preferred service information (SI) to determine if there is a match; and (d) scheduling the recording of a matching event from the broadcast stream in the case of a match.

In accordance with another aspect of the invention, a system for scheduling the recording of audiovisual information received as part of a composite transport stream over a communication medium, wherein the composite transport stream is comprised of a plurality of channels, each channel being further comprised of a plurality of events and content description information describing the plurality of events, comprises a receiver comprised of: (i) a processor configured to: (a) store user preference criteria comprising at least one user preferred service and associated user preferred service information (SI); (b) extract service information for a plurality of events to be broadcast on the at least one user preferred service; (c) compare the extracted service information with the user preferred service information associated with the at least one user preferred service; (ii) a schedule module for scheduling the recording of one of said plurality of events to be broadcast on the at least one user preferred service when the comparison results in a match.

In yet another aspect, the invention relates to an article of manufacture, according to one embodiment, having embodied thereon computer-readable program means for automatically recording audiovisual information received as part of a broadcast stream over a communication medium, wherein the broadcast stream is comprised of a plurality of services, each service being further comprised of a plurality of events and service information describing the plurality of events, generally comprises the acts of: (a) creating user preference criteria comprised of at least one user preferred service and associated user preferred service information (SI); (b) extracting service information (SI) from the broadcast stream for a plurality of events to be broadcast on the at least one user preferred service; (c) comparing the extracted service information (SI) with the user preferred service information (SI) to determine if there is a match; and (d) scheduling the recording of a matching event from the broadcast stream in the case of a match.

The foregoing features of the present invention will become more readily apparent and may be understood by referring to the following detailed description of an illustrative embodiment of the present invention, taken in conjunction with the accompanying drawings, where:

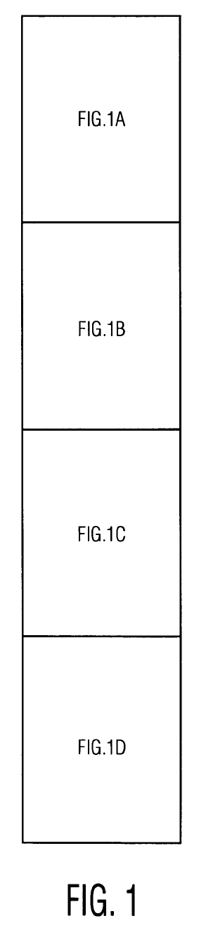

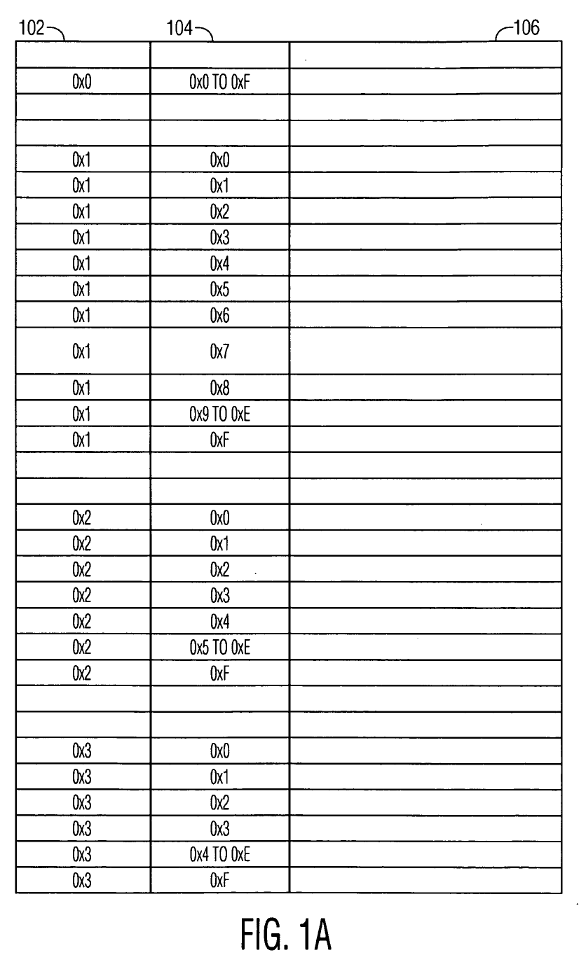

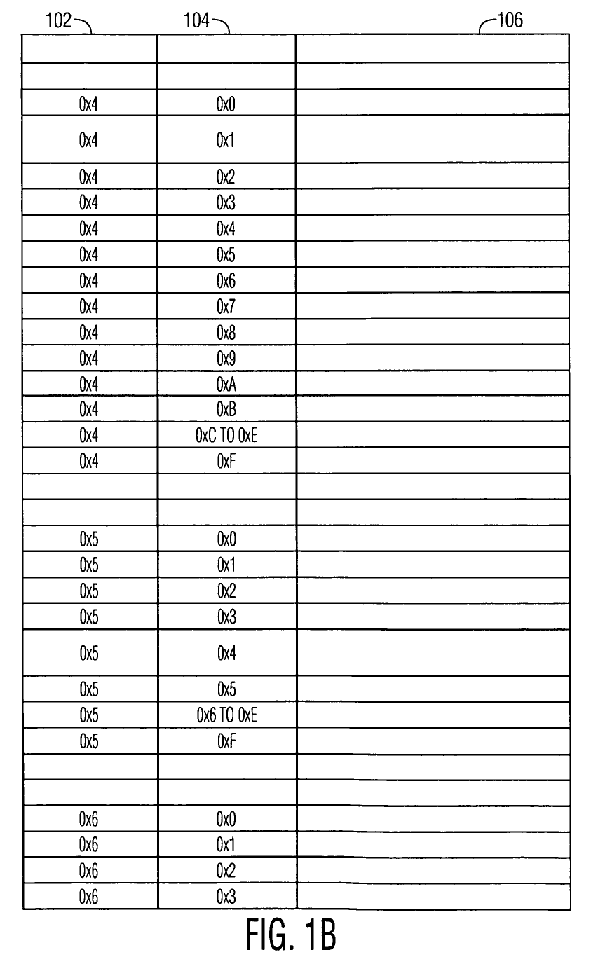

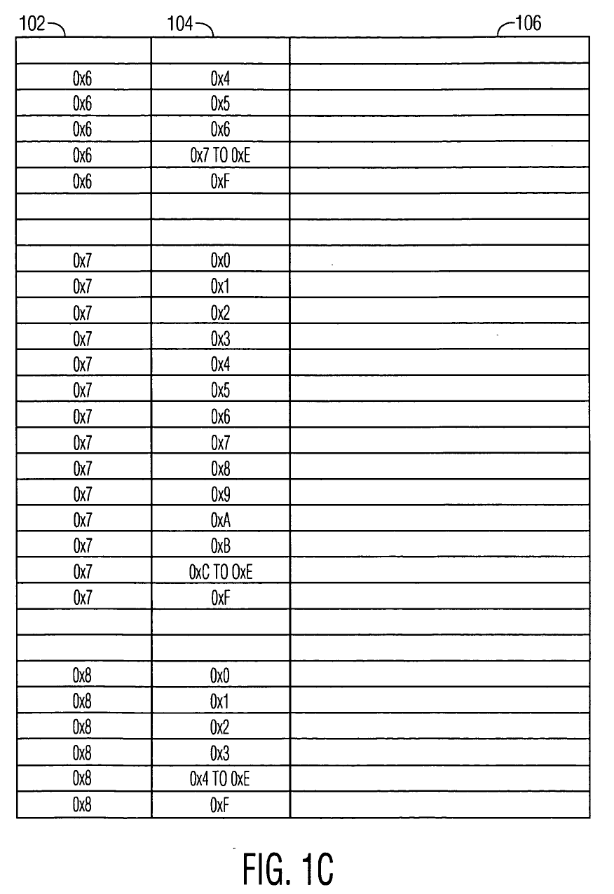

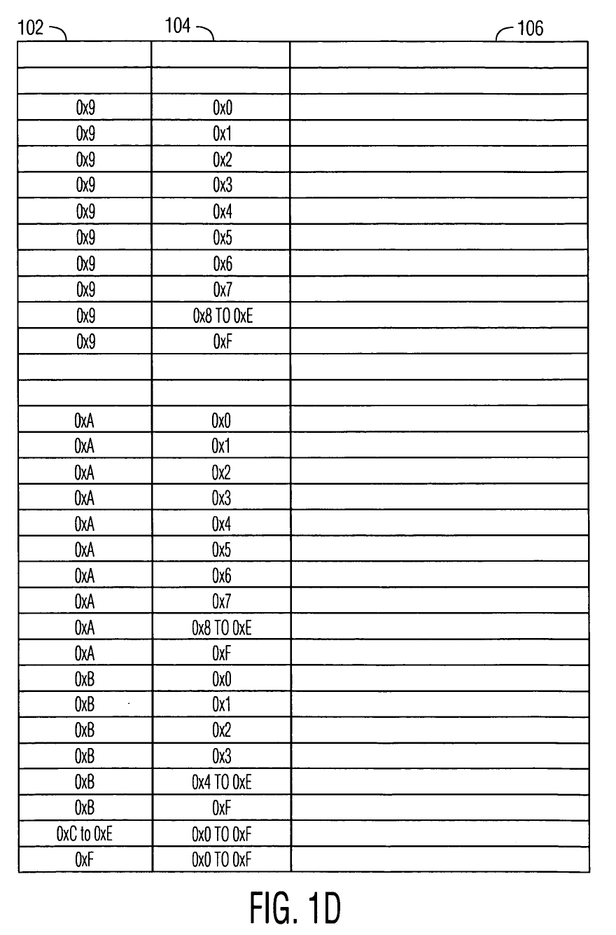

FIG. 1 is a table describing the content descriptors for providing classification information for an event in accordance with the DVB standard;

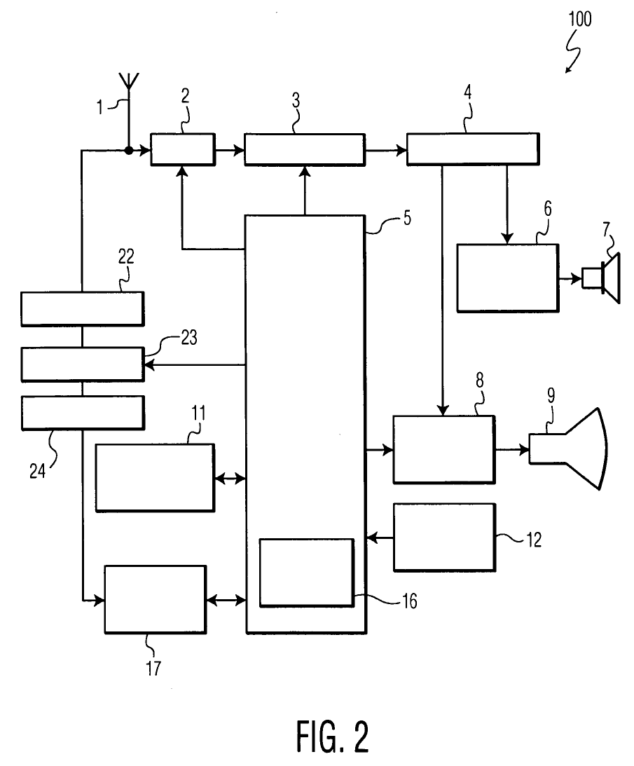

FIG. 2 shows a diagram of a digital television receiver as an embodiment of the apparatus according to the invention;

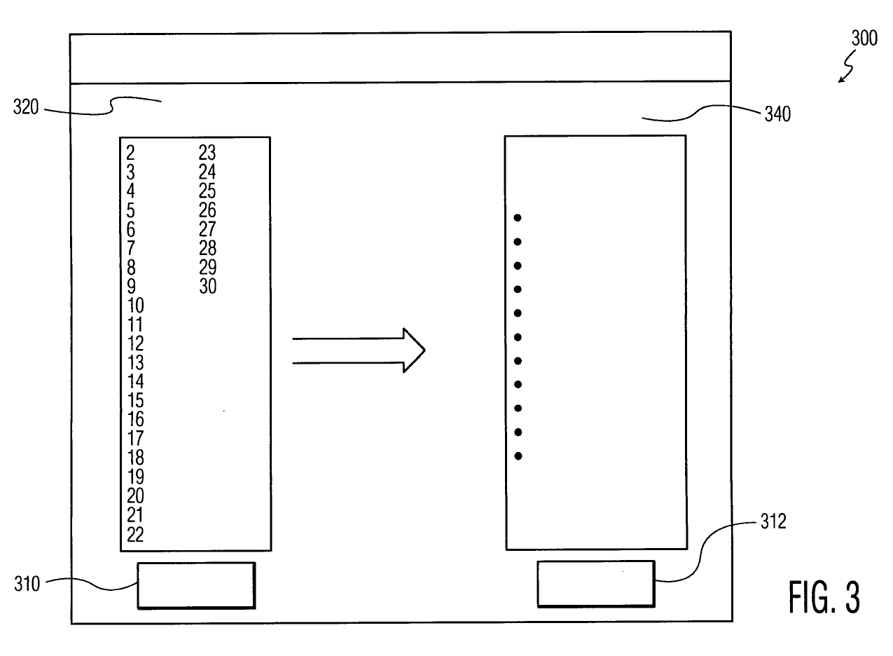

FIG. 3 is an exemplary display image window of a GUI screen that is shown to a user to enable the setting of user criteria in accordance with an embodiment of the invention;

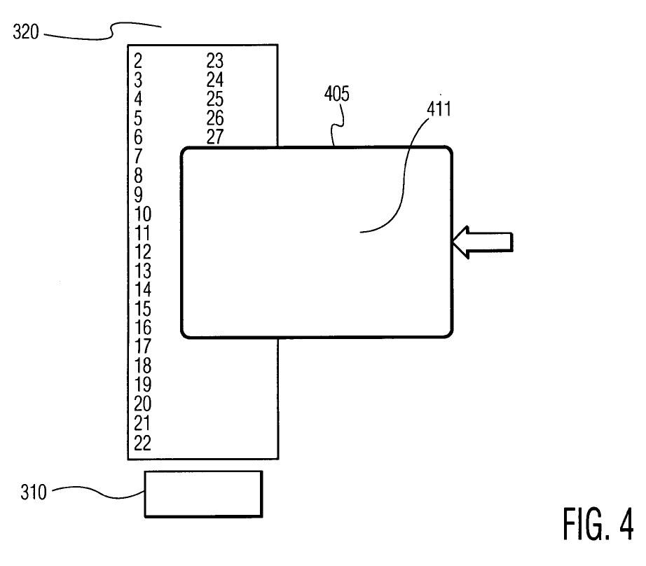

FIG. 4 is an exemplary display image window of a GUI screen shown to a user in response to the user selecting an event type from the GUI screen of FIG. 3; and

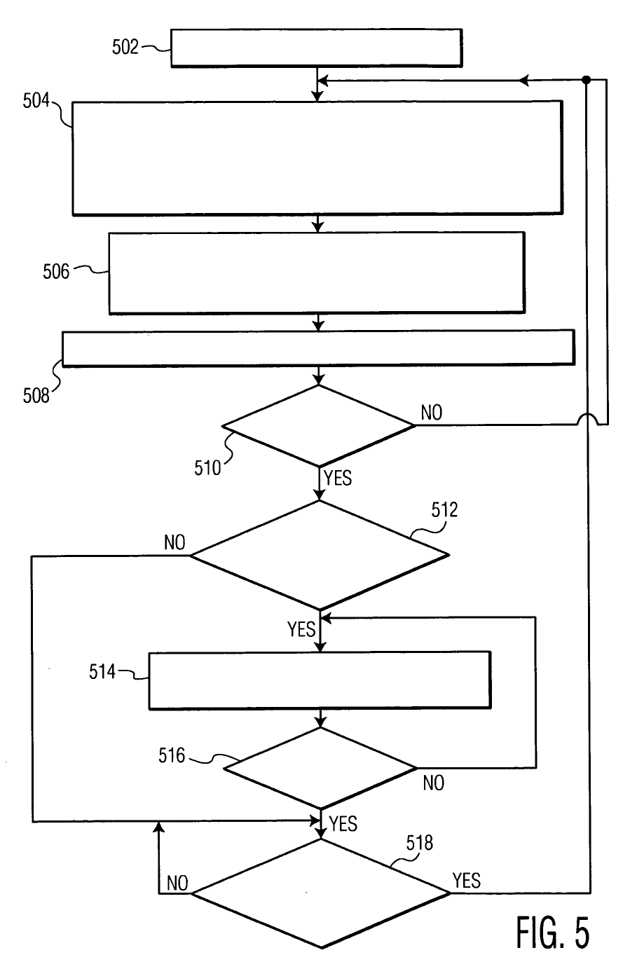

FIG. 5 is a flow chart showing the acts involved in automatically scheduling audiovisual information recording based on service in accordance with an embodiment of the invention.

The following description is presented to enable any person of ordinary skill in the art to make and use the present invention. Various modifications to the preferred embodiment will be readily apparent to those of ordinary skill in the art, and the disclosure set forth herein may be applicable to other embodiments and applications without departing from the spirit and scope of the present invention and the claims hereto appended. Thus, the present invention is not intended to be limited to the embodiments described, but is to be accorded the broadest scope consistent with the disclosure set forth herein.

For purposes of this disclosure, “Broadcast” shall mean when video content is made available to the public, such as by television and cable broadcasts, and also pay-per-view, and video on demand broadcasts.

The standard most widely used in Europe for video and audio transmission, and for certain other types of data, is the digital video broadcast (DVB) System. The present invention will be described in this non-limiting context. It is understood, however, that the invention is more generally applicable to standards other than the DVB standard.

In accordance with the DVB standard, a composite transport stream is referred to as a DVB stream. A typical DVB stream will contain a number of video and audio channels along with reference data for referencing the video/audio channels. The reference data is commonly referred to as service information (SI) defined in the DVB-SI specifications (“Digital Video Broadcast—specification for Service Information”) EN 300 468 V1.5.1 (published by the ETSI), incorporated by reference herein in its entirety. The reference data can include, for example, subtitles, teletext, information on program schedules, information for conditional access used for pay-TV, and tables which show how to combine different parts of these features to provide any of the possible services. The reference data takes the form of tables and descriptors which describe the services (channels) transmitted on the broadcasting network. A service is an uninterrupted series of events broadcast on a specified broadcast stream.

In particular, in accordance with the DVB-SI standard, the reference data is defined in tables such as: NIT, SDT, EIT and possibly BAT. With the aid of the data contained in the NIT, SDT, EIT and possibly BAT tables, the receiver knows the general content of the audiovisual transmissions broadcast by the network. The NIT table gives the general structure of the network and indicates the list of transport streams and services broadcast. The SDT table gives additional information relating to the services, for example the unencrypted name of a service. The BAT table contains information on several services clustered together into a bouquet of services which can be output by several broadcasting networks.

From among those tables defined in the DVB-SI standard, the EIT tables is of particular interest for purposes of the invention. The EIT tables indicate a list of events for each service, and makes it possible in particular to indicate the events currently being broadcast. More particularly, the EIT tables describes the content of the events by virtue of its event descriptors such as the events start time, duration, short event descriptor, extended event descriptor, content descriptor, etc. For example, the DVB standard, ETSI EN 300 468 V1.5.1, specifies eleven event (program) classifications which are included in the EIT table data. The eleven event classifications include: (1) Music, (2) Arts, (3) Social, (4) Education, (5) Leisure, (6) Movies, (7) News, (8) Show, (9) Sports, (10) Children's and (11) Special Characteristics. The DVB standard further defines a plurality of event sub-classifications which further define the eleven event classifications. The DVB standard describes how the event classification and sub-classification information is coded for each event using a Content_nibble_level_{—}1 field and a Content_nibble_level_{—}2 field, as shown in Table I.

TABLE I

| SYNTAX | | No. of bits | Identifier |
|---|---|---|---|
| Content_descriptor( ){ | | | |
| | descriptor_tag | 8 | Uimsbf |
| | descriptor_length | 8 | Uimsbf |
| | For (i=0;i<N;i++) | | |

| | | |
|---|---|---|
| Content_nibble_level_1 | 4 | Uimsbf |
| Content_nibble_level_2 | 4 | Uimsbf |
| User_nibble | 4 | Uimsbf |
| User_nibble | 4 | Uimsbf |

}

}

As shown in Table I, the content_nibble_level_{—}1 field is a 4-bit field that represents a first level of content (event) identification. The content_nibble_level_{—}2 field is a 4-bit field that represents a second level, more granular, level of content (event) identification.

FIG. 1 is an illustration of the eleven event categories and the respective event classifications and sub-classifications defined in each category, as specified in the DVB standard, ETSI EN 300 468 V1.5.1. As shown, FIG. 1 includes three columns, a first column 102 entitled the “content_nibble_level_{—}1” field, as described above. This field describes how the eleven event classifications are coded. For example, 0x3 corresponds to the classification, “Shows”. The second column 104 entitled the “content_nibble_level_{—}2” field defines how the second, more granular, level of content classification is coded. For example, for the event classification “MUSIC”, whose content_nibble_level_{—}1 coding specification is (0x6), the second column 104 illustrates the coding for each of the respective event sub-classifications: “music/ballet/dance” (0x0), “rock/pop” (0x1), “serious music/classical music” (0x2) and so on.

The third column 106 of FIG. 1 lists the actual classifications and sub-classifications in text form.

FIG. 2 shows a block diagram of a digital television receiver 100 according to one embodiment for carrying out the method of the invention. Digital broadcast streams, modulated upon radio frequency (RF) signals, are received by an antenna 1 or, alternatively, from a broadcast source such as, for example, a cable network (not shown). In the preferred embodiment, the broadcast streams may be formatted, for example, in accordance with the Digital Video Broadcasting (DVB) standard.

Two tuners 2, 22 comprise standard analog RF receiving devices which are capable of receiving the RF signals and selecting one of them to be output to a respective demodulator 3, 23. The demodulators 3, 23 convert the respective analog signals into a digital packet stream, based on control signals received from the CPU 5. The packet streams are then output to respective demultiplexers 4, 24 which select packets belonging to a particular program in accordance with control data received from the CPU 5, and decomposes the packet stream into elementary video, audio or data streams.

In the preferred embodiment, one tuner 2 is dedicated for use by a user for watching TV programs, as is conventional. A second tuner 22 is used to parse the broadcast stream to extract service information (DVB-SI data) there-from.

A video processor 8 decodes the video stream received from the first demultiplexer 4. The video processor 8 is an MPEG-2 decoder; however, any decoder may be used as long as the decoder is compatible with the type of coding used to code the video data. Decoded video data is then transmitted to a display screen 9. An audio processor 6 decodes the audio stream received from the demultiplexer 4. Again, any decoder may be used as long as the decoder is compatible with the type of coding used to code the audio data. Decoded audio data is then transmitted to a speaker system 7.

To facilitate the parsing of service information (DVB-SI data) from the broadcast stream, the second demultiplexer 24 output an elementary data stream to the digital video recorder 17. The digital video recorder 17 is controlled by the CPU 5, and capable of storing and reproducing programs and DVB-SI data. It may be built in the television receiver or be a separate device under control of the television receiver.

The elementary data streams have two types of data: control data and content data. Content refers to, e.g., interactive programs. Control data refers to tables in the broadcast stream which specify matters like the structure of the broadcast stream, the (RF) frequencies at which the services are modulated, and the addresses at which the various content components and the (other) tables in the broadcast stream can be found. In an application in accordance with the Digital Video Broadcasting (DVB) standard, control data refers to DVB-SI data including tables such as the NIT, SDT, EIT and possibly BAT tables discussed above. The EIT tables indicate, inter alia, for each broadcasted event, content (event) descriptors including the content_nibble_level_{—}1 field and the content_nibble_level_{—}2, described above.

The CPU 5 comprises one or more microprocessors capable of executing program instructions stored in a read-only memory (ROM) 12. As used herein, a processor comprises any one or combination of, hardware, firmware, and/or software. A processor acts upon information by manipulating, analyzing, converting or transmitting information for use by an executable procedure or an information device, and/or by routing the information to an output device.

In operation, in accordance with the DVB standard, a user specifies and stores user preference criteria including service information (DVB-SI data) in combination with service to schedule the automatic recording of audiovisual information from a DVB broadcast stream. The user preference criteria may be entered, in one way, by the user pre-programming into the non-volatile memory 11 or read only memory 12, preferably via a GUI interface, the user criteria including service in combination with service information. As discussed above, service constitutes one or more user preferred services (channels) and service information includes at least an event classification and preferably an event sub-classification.

Table II illustrates, by way of example, the stored user preference criteria.

TABLE II
(User Preference Criteria)

| | Event | Event Classification |
|---|---|---|
| User Preferred Services | Classification Type | Sub-type |
| 21 | Movies | Comedies |
| 21 | Sports | — |
| 7 | Music | Rock/pop |
| 2 | Education | — |
| 5 | Leisure | Cooking |
| 29 | Arts | Performing Arts |
| 30 | Children's | — |

Table II illustrates that the user has elected to select and store 6 services (channels) considered by the user to be user preferred services: channels 2, 5, 7, 21, 29 and 30. As shown, the user has further elected to select and store at least an one event classification for each user preferred service and in one case 2 event classifications (see service 21, event classifications —“Movies” and “Sports”). The user has further elected to select a sub-classification for 4 of the 6 event classifications specified.

It should be noted that there is no restriction on the number of event classification types/sub-types that a user may specify. The only restriction on service is the number of services made available.

FIG. 3 is an exemplary display image window of a GUI screen 300 that is shown to a user to create the user preference criteria (e.g., Table II) in accordance with the DVB standard. The user preference criteria may preferably be stored in either the non-volatile memory 11 or the read-only memory 12 of the receiving/recording device shown in FIG. 1.

The user creates preference criteria by first selecting and storing one or more user preferred services (channels). The GUI screen 300 shows on the left hand side a “SERVICE SELECTOR” listing 320 that is used to select one or more user preferred services (channels). This may be performed by highlighting a service (channel) from the service selector listing 320 via mouse or keyboard selection and depressing the select icon 310. Assume, for example, that the user selects service 8 as a first user preferred channel from those shown.

The user then selects at least an event classification type from the “EVENT TYPE SELECTOR” listing 340 shown in the right hand portion 340 of GUI screen 300 which lists 11 event types in accordance with the current DVB standard. It should be appreciated that future versions of the DVB standard may include more, less and/or different event types for selection. An event type may be selected by highlighting an event type from those shown via mouse or keyboard selection and depressing the select icon 312. In the illustrative example, assume the user selects the “Leisure” event type 315 from the event selector listing 340 for user preferred service 8.

FIG. 4 is an exemplary display image window of one embodiment of a GUI screen 400 shown to a user in response to the user selecting the “Leisure” event type 315 at GUI screen 300 and depressing the select icon 312 of FIG. 3. The pop-up window 405 shown in the GUI screen 400 of FIG. 4 includes the various event sub-classifications that further define the “Leisure” event type 315 as defined by the DVB standard. In particular, eight sub-classifications are shown in pop-up window 405. This pop-up window 405 allows the user to select one or more user preferred event sub-classifications related to the “Leisure” event type. Assume, for the sake of example, that the user chooses the “motoring” sub-category 411.

At this point, the selected event type/sub-classification type, namely, “Leisure/motoring” is entered and stored as part of the user preference criteria.

| User Preferred Services | Event Classification | Event Sub-Classification |
|---|---|---|
| 8 | Leisure | motoring |

This process may be repeated to select additional user preference criteria, as shown by way of example in the exemplary user preference criteria table listing of Table II above.

FIG. 5 is a flow chart showing the acts involved in automatically scheduling audiovisual information recording based on service and service information (SI) in accordance with one embodiment. The flow chart will be described, by way of example, with reference to FIG. 1 and table II above and table III below.

At Act 502, a user creates and stores user preference criteria (e.g., Table II above) in accordance with the DVB standard, including one or more user preferred services (channels) and associated service information (e.g., user preferred event classifications and sub-classifications).

At Act 504, a second tuner 22 (FIG. 1) is sequentially tuned to each service (channel) N specified by the user in the user preference criteria as a user preferred service. This operation is performed under control of the CPU 5. During the time the second tuner 22 is tuned to the ith service, next event information is extracted from EIT tables transmitted in the broadcast stream for that service. The next event information specifies event classification types and sub-types for events to be broadcast on the ith service in the near future. In the instant example, the second tuner 22 is tuned to the following N=6 services (channels) in sequence: service (channel) 2, 5, 7, 21, 29 and 30 to capture next event information.

Table III, illustrates exemplary EIT table data comprised of next event information which, for purposes of illustration, is assumed to have been extracted from the user preferred services specified in the instant example.

TABLE III

| Service | Event 1 | Event 2 | Event 3 | Event 4 |
|---|---|---|---|---|
| (Channel) | Type/sub-type | Type/sub-type | Type/sub-type | Type/sub-type |
| 2 | Movie/comedy | Sports/football | Education/nature | Social/documentary |
| 5 | Arts/culture | Music/rock | Education/languages | Show/variety show |
| 7 | News/current | Movie/soap | Sports/athletics | Children's/cartoons |
| | affairs | | | |
| 9 | Children's/pre- | Show/game show | Move/thriller | News/discussion |
| | school | | | |
| 21 | Movie/comedy | Sports/water | Sports/martial | Education/spiritual |
| | | | | sciences |
| 29 | Arts/culture | Music/rock | Music/rock | Education/animals |
| 30 | News/debate | Movie/soap | Movie/soap | Sports/equestrian |

At Act 506, for each user preferred service, a comparison is made between the user preferred event classification types and sub-types for each service (see Table II) and the next event information extracted from the EIT table in the broadcast stream for that service (see table III) to determine if there is a match. For example, for the user preferred service (channel) 2, the stored user preferred event classification type(s) and sub-type(s) are described in Table II, and repeated as follows:

| | Event | Event Classification |
|---|---|---|
| User Preferred Services | Classification Type | Sub-type |
| 2 | Education | — |

The user preferred criteria for service (channel) 2, i.e., “Education”/“-----” is compared with the next event information extracted from the EIT tables of the broadcast stream for service (channel) 2:

| | Event 1 | Event 2 | Event 3 | Event 4 |
|---|---|---|---|---|
| Channel | Type/sub-type | Type/sub-type | Type/sub-type | Type/sub-type |
| 2 | Movie/comedy | Sports/football | Education/nature | Social/documentary |

It is shown that there is a match between the user preferred criteria and the “Type” for Event 3, i.e., “Education”.

At Act 508, all matching events are sent to the scheduler module 16 to be queued for recording.

Act 510 is a determination step to determine if all of the user preferred services have been parsed for next event information. If no, the process returns to act 504. Otherwise, the process continues at act 512.

Act 512 is a determination step to determine whether there is at least one event in the scheduling queue that is ready to be recorded. That is, the event has a broadcast time substantially equal to the present time.

At act 514, second tuner 22 begins to record the at least one event, identified at act 512 that is ready to be recorded. It is noted that the second tuner 22 is not available to parse the broadcast stream for next event information during the recording time.

Act 516 is a determination step to determine whether the recording is complete. If no, the process loops back to act 514 and continues to record. Otherwise, the process continues at act 518.

Act 518 is a determination act whereby the broadcast stream is parsed to determine if updated EIT table data is available for the user preferred services. If no, the process continues in this loop. Otherwise, the process loops back to act 504.

It is noted that the user has the option of modifying the user preference criteria at any point in time. It is also noted that the user has the further option of turning off (disabling) the automatic recording feature of the invention at any point in time.

In certain embodiments, the user preference criteria (as shown in Table II) could be prioritized. The prioritization could be constructed in one way such that the first entry has the highest priority and the remaining entries have priorities in descending order. In other words, the priority order of the channels is their listing order. Prioritization can therefore resolve any potential scheduling conflicts.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) every “means” may be represented by the same item or hardware or software implemented structure or function; and

e) each of the disclosed elements may be comprised of hardware portions (e.g., discrete electronic circuitry), software portions (e.g., computer programming), or any combination thereof.

1. A method for automatically recording audiovisual information received as part of a broadcast stream over a communication medium, wherein the broadcast stream is comprised of a plurality of services, each service being further comprised of a plurality of events and service information describing the plurality of events, the method comprising the acts of:
(a) creating user preference criteria comprised of at least one user preferred service and associated user preferred service information (SI);
(b) extracting service information (SI) from the broadcast stream for a plurality of events to be broadcast on the at least one user preferred service;
(c) comparing the extracted service information (SI) with the user preferred service information (SI) to determine if there is a match; and
(d) scheduling the recording of a matching event from the broadcast stream in the case of a match.

2. The method according to claim 1, further comprising the acts of storing the created user preference criteria in a data repository (11, 12) and later retrieving said user preference criteria at said comparison act.

3. The method according to claim 1, wherein the broadcast stream can be sourced from a plurality of audiovisual signal sources including one of a Broadcast TV signal from an antenna, a cable TV connection, a satellite, a Web TV signal, a digital video delay and a playback apparatus.

4. The method according to claim 1, wherein the act of extracting service information (SI) from the broadcast stream further comprises the act of extracting an electronic information table (EIT) table data associated with the at least one user preferred service.

5. The method of claim 4, wherein the EIT table data comprises content descriptors which describe at least a classification type and a classification sub-type for each of the plurality of events to be broadcast at a future time on the at least one preferred service.

6. The method of claim 5, wherein the act of comparing comprises comparing the content descriptors extracted from the broadcast stream for each of the plurality of events with the associated user preferred service information (SI).

7. The method according to claim 5, wherein the classification type is coded as a content_nibble_level_{—}1 field and the classification sub-type is coded as a content_nibble_level_{—}2 field in accordance with the DVB standard.

8. The method according to claim 5 where the classification type comprises music, arts, social, education, leisure, movies, news, show, sports, children's, and special characteristics

9. The method of claim 1, wherein the composite transport stream is a stream conformant to the Digital Video Broadcast (DVB) specifications, the service information constituting the Electronic Information Table (EIT) of the DVB Service Information (SI).

10. A method for automatically scheduling the recording of audiovisual information received as part of a composite transport stream over a communication medium, wherein the composite transport stream is comprised of a plurality of channels, each channel being further comprised of a plurality of events and content description information describing the plurality of events, the method comprising the acts of:
(a) pre-storing user preference criteria comprising at least one user preferred channel and associated user preferred content description information prior to receiving the composite transport stream over the communication medium;
(b) extracting content description information from the composite transport stream for a plurality of events to be broadcast on the at least one user preferred channel;
(c) comparing the extracted content description information with the user preference criteria; and
(d) scheduling the recording of at least one broadcast event on the at least one user preferred channel when a match occurs at act (c).

11. The method according to claim 10, wherein the composite transport stream can be sourced from a plurality of audiovisual signal sources including one of a Broadcast TV signal from an antenna, a cable TV connection, a satellite, a Web TV signal, a digital video delay and a playback apparatus.

12. A system (100) for scheduling the recording of audiovisual information received as part of a composite transport stream over a communication medium, wherein the composite transport stream is comprised of a plurality of channels, each channel being further comprised of a plurality of events and content description information describing the plurality of events, the system comprising:
a receiver comprised of:
(i) a processor (5) configured to:
(a) store user preference criteria comprising at least one user preferred service and associated user preferred service information (SI);
(b) extract service information for a plurality of events to be broadcast on the at least one user preferred service;
(c) compare the extracted service information with the user preferred service information associated with the at least one user preferred service;
(ii) a scheduler module (16) for scheduling the recording of one of said plurality of events to be broadcast on the at least one user preferred service when the comparison results in a match.

13. The system of claim 12, further comprising at least one data repository for storing the user preference criteria.

14. The system (100) of claim 13, wherein the data repository is one of a non-volatile memory (11) and a read only memory (12).

15. The system (100) of claim 12, further comprising a first tuner (2) and a second turner (22) for receiving an RF signal.

16. The system (100) of claim 15, further comprising a first (3) and second demodulator (23) for demodulating the RF signal and a first (4) and second (24) demultiplexer for converting the demodulated signal into a digital packet stream under control of the processor (5).

17. The system (100) of claim 16, further comprising a digital video recording device for recording one of said plurality of events to be broadcast on the at least one user preferred service when the comparison results in a match

18. A system (100) for scheduling the recording of audiovisual information received as part of a composite transport stream over a communication medium, wherein the composite transport stream is comprised of a plurality of channels, each channel being further comprised of a plurality of events and content description information describing the plurality of events, the system comprising:
means for creating user preference criteria comprised of at least one user preferred service and associated user preferred service information (SI);
means for extracting service information (SI) from the broadcast stream for a plurality of events to be broadcast on the at least one user preferred service;
means for comparing the extracted service information (SI) with the user preferred service information (SI) to determine if there is a match; and
means for scheduling the recording of a matching event from the broadcast stream in the case of a match.

19. The system of claim 18, further comprising means for storing the user preference criteria.

20. The system of claim 17, wherein the means for storing the user preference criteria data repository is one of a non-volatile memory (11) and a read only memory (12).

21. An article of manufacture for scheduling the recording of audiovisual information received as part of a composite transport stream over a communication medium, wherein the composite transport stream is comprised of a plurality of channels, each channel being further comprised of a plurality of events and content description information describing the plurality of events, the article of manufacture having computer readable code means embodied thereon, said computer readable program code means comprising:
an act of creating user preference criteria comprised of at least one user preferred service and associated user preferred service information (SI);
an act of extracting service information (SI) from the broadcast stream for a plurality of events to be broadcast on the at least one user preferred service;
an act of comparing the extracted service information (SI) with the user preferred service information (SI) to determine if there is a match; and
an act of scheduling the recording of a matching event from the broadcast stream in the case of a match.
